(19) United States
(12) Patent Application Publication
(10) Pub. No.: US 2012/0158677 A1
(43) Pub. Date: Jun. 21, 2012

(54) SYSTEMS AND METHODS FOR STREAMING COMPRESSED FILES VIA A NON-VOLATILE MEMORY

(75) Inventor: Shachar Ron, Sunnyvale, CA (US)

(73) Assignee: Apple Inc., Cupertino, CA (US)

(21) Appl. No.: 12/973,580

(22) Filed: Dec. 20, 2010

(51) Int. Cl. G06F 17/30

(52) U.S. Cl. 707/693; 707/E17.002

(57) ABSTRACT

This can relate to streaming compressed files via a non-volatile memory (“NVM”) of a media player. In particular, the NVM can stream compressed media files. The NVM can include an NVM controller and an NVM die storing the compressed media file. The NVM controller can read the compressed media file from the NVM die, decompress the media file, and send the decompressed media file to a digital-to-analog converter (“DAC”) for conversion to analog format. Since the decompression can be performed by the NVM itself, an application processor may be significantly removed from the media playback process. In some embodiments, it may only be necessary for the application processor to issue an initial read request and/or receive a completion confirmation from the NVM. This can result in significant power savings for the media player and can free the application processor for performing other functions of the media player.

### FIELD OF THE INVENTION

Systems and methods are disclosed for streaming compressed files via a non-volatile memory. In particular, the non-volatile memory can decompress media files and directly stream them towards media output circuitry.

### BACKGROUND OF THE DISCLOSURE

Non-volatile memory (“NVM”), such as NAND flash memory, is commonly used for mass storage. In particular, NAND flash memory is popularly used in media player systems (e.g., a portable media player such as an iPod™, a cellular phone, or other device capable of playing media) for storing media files such as audio files, video files, and the like.

In traditional media player systems, the media file is often stored in the non-volatile memory as a compressed file. For example, such compressed audio files can include an mp3 file, as an AAC file, or as any other suitable compressed file type. The stored, compressed media file is then read from the non-volatile memory by an application processor (“AP”) of the media player system. The application processor may decompress the media file and pass it to a digital-to-analog converter (“DAC”) for conversion into analog form. The DAC may then pass the decompressed, analog media file to appropriate input/output (“I/O”) circuitry for playback (e.g., playback via speakers, a monitor, or both).

Generally, the non-volatile memory was considered to be “dumb” hardware that could merely store or pull data under explicit instructions from the application processor and could not perform other functions. Therefore, the bulk of the work in processing media files for playback would fall upon the application processor. Since the application processor could thus be tied up in processing and decompressing media files, the overall operation of the media player system could be slowed down and/or a substantial amount of power consumed. These results could especially be detrimental to portable media player systems that often have limited battery life and/or processing power.

### SUMMARY OF THE DISCLOSURE

Systems and methods are disclosed for streaming compressed files via a non-volatile memory (“NVM”). In particular, an NVM package of a media player system can internally decompress a compressed media file. The decompressed media file can then be streamed directly from the NVM package towards suitable output circuitry.

In particular, the NVM package can include one or more NVM dies (e.g., integrated circuits) that may store the compressed media files. The NVM package may also include an NVM controller that can perform the decompression of the media files. The decompressed media file may then be output from the NVM package towards any suitable media player system components to further process the media file for playback. For example, the decompressed media file can be output from the NVM package towards a digital-to-analog converter (“DAC”), towards input/output circuitry, towards an input/output device (e.g., speakers, a monitor, or the like), or towards any other suitable components.

In this manner, since the NVM package may decompress the media file in place of an application processor (“AP”), the application processor can be available to perform other tasks during this time (e.g., thus allowing the media player system to multitask and increasing its overall operating speed) and/or the application processor can be turned off or put into a low-power state (e.g., thus increasing the battery life of the media player system). Moreover, since the compressed files can both be stored and decompressed within the NVM package, the application processor may never even encounter a compressed media file and may be substantially removed from the media playback process. In some cases, the application processor's only role in the media playback process may be to send an initial playback request to the NVM package and/or to receive a completion confirmation from the NVM package once the processing is complete.

Moreover, in addition to decompression, the NVM package can compress media files. For example, the media player system may receive a raw media file from any suitable input device such as, for example, a microphone, a digital camera, a video camera, and the like. The raw media file may then be provided to the NVM package (e.g., after any analog-to-digital conversion or other suitable processing has been performed on the raw media file).

The NVM package may then internally compress and store the raw media file.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIG. 1 is a schematic view of a media player system configured in accordance with some embodiments of the invention;

FIG. 2 is an illustrative process for playing back a media file in accordance with some embodiments of the invention;

FIG. 3 is an illustrative process for streaming a media file via a non-volatile memory in accordance with some embodiments of the invention;

FIGS. 4A and 4B are schematic views of non-volatile memory packages including CODEC in accordance with some embodiments of the invention;

FIGS. 5 and 6 are illustrative processes for decompressing media files with a non-volatile memory in accordance with some embodiments of the invention;

FIG. 7 is a schematic view of a media player system configured in accordance with some embodiments of the invention;

FIG. 8 is an illustrative process for streaming a media file via the media player system of FIG. 7 in accordance with some embodiments of the invention;

FIG. 9 is a schematic view of a media player system configured in accordance with some embodiments of the invention; and

FIG. 10 is an illustrative process for compressing a media file via a non-volatile memory in accordance with some embodiments of the invention.

### DETAILED DESCRIPTION OF THE DISCLOSURE

Systems and methods for streaming compressed files via a non-volatile memory (“NVM”) are provided herein. In particular, a media player system can include an NVM package and an application processor (“AP”). The NVM package can store various compressed media files (e.g., compressed audio files such as mp3 files, compressed picture files such as jpeg files, compressed video files, and the like). Generally, when playback of a compressed media file is desired, the application processor can retrieve the media file from the NVM package. The application processor may then decompress the media file and forward the decompressed media filed towards any suitable media player system components to further process the media file for playback (e.g., towards a digital-to-analog converter, towards output circuitry, and the like). However, using the application processor to decompress media files in this manner can result in slowing down the overall performance of the media player system (e.g., since the application processor may be unavailable to perform other functions) and can waste system power.

Accordingly, in some embodiments the NVM package can internally decompress the compressed media files, thus freeing up the application processor to perform other functions. For example, the NVM package may include an NVM controller with suitable processing power to decompress the media files. The decompressed media file may then be directly streamed from the NVM package towards suitable media playback components. In this manner, since the compressed files are both stored and decompressed within the NVM package, the application processor may never even encounter a compressed media file and may be substantially removed from the media playback process.

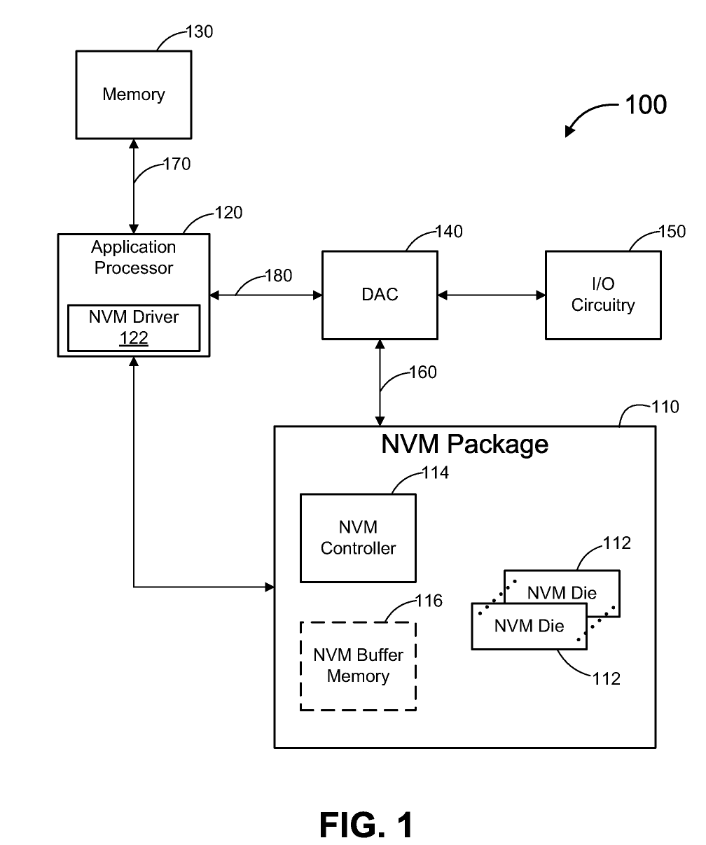

FIG. 1 shows a schematic view of an illustrative media player system 100. Media player system 100 can include any electronic device or system suitable for storing and playing media files. For example, media player system 100 can include a portable media player, a cellular telephone, a pocket-sized personal computer, a personal digital assistance (“PDA”), a handheld gaming device, a desktop computer, a laptop computer, or any other suitable type of media player system.

Media player system 100 can include NVM package 110, application processor (“AP”) 120, memory 130, digital-to-analog converter (“DAC”) 140, and input/output (“I/O”) circuitry 150. Only one of each component is shown in FIG. 1 for the purpose of simplicity. However, one skilled in the art could appreciate that more than one of each component or any suitable additional components (e.g., such as a power supply, any user input or output components, error correcting code modules) could additionally be included.

NVM package 110 can include any suitable package having non-volatile memory and one or more integrated circuits. For example, NVM package 110 may include various integrated circuits coupled together on a single printed circuit board through a ball grid array (“BGA”) pattern, coupled together through a pin grid array (“PGA”) pattern, or can include any other suitable type of integrated circuit package.

NVM package 110 can include one or more instance of NVM die (i.e., integrated circuit) 112. Each instance of NVM die 112 can include a NAND flash memory based on floating gate or charge trapping technology, NOR flash memory, erasable programmable read only memory (“EPROM”), electrically erasable programmable read only memory (“EEPROM”), Ferroelectric RAM (“FRAM”), magnetoresistive RAM (“MRAM”), or any combination thereof. FIG. 1, as well as later figures and various disclosed embodiments, may sometimes be described in terms of using flash technology. However, this is not intended to be limiting, and any other type of non-volatile memory can be implemented instead.

NVM dies 112 may be used to store any suitable information that is to be retained when media player system 100 is powered down. For example, NVM dies 112 can store compressed media files, other user files, software application information, user profile information, or any other suitable information. As used herein, and depending on context, a “non-volatile memory” can refer to NVM dies in which data can be stored or may refer to an NVM package that includes the NVM dies. Moreover, in general when a NVM, digital-to-analog converter, or other device processes a “media file,” at a technical level the processed data may simply include bytes of data such as those stored in blocks and pages of NVM dies 112. As such, as used herein and as determined by context, the term “media file” can refer to the media file itself or can refer to a set of data correlated to the media file (e.g., and which is processed by a NVM or other component of the media player system).

Each instance of NVM die 112 can be organized into “blocks”, which is the smallest erasable unit. Each block may then be further organized into “pages”, which can be the smallest unit that can be programmed or read. Each page can correspond to a particular “physical page address” of the NVM, where data can be written to and/or read from the physical page address. Similarly, each block of NVM 120 can be addressed using a “physical block address,” where data can be erased from each physical block address. Each page and block can also be associated with a logical page address and a logical block address, respectively, which other components of media player system 100 (e.g., application processor 120) may use to address these pages and blocks.

As illustrated by FIG. 1, NMV package 110 can include NVM controller 114 which may be any suitable combination of processors, microprocessors, hardware-based components (e.g., ASICs), and/or any other suitable control circuitry. NVM controller 114 can be coupled to any suitable number of NVM dies 112. NVM controller 114 may perform substantially all of the management and access functions for NVM dies 112. Alternatively, NVM controller 114 may share the responsibility of managing and/or accessing the physical memory locations of NVM dies 112 with an NVM driver external to NVM package 110, such as NVM driver 122. In general, however, NVM controller 114 can include sufficient processing power to perform any suitable memory management and data processing functions, such as issuing read/write/erase instructions, performing wear leveling, performing bad block management, performing garbage collection, performing logical-to-physical address mapping, applying error correction/detection, and decompressing/compressing data stored in NVM dies 112.

NVM package 110 may also optionally include NVM buffer memory 116. For example, NVM buffer memory 116 can include a volatile memory which may temporarily hold data being processed by NVM controller 114. As a particular illustration, NVM buffer memory 116 may temporarily hold media file data as NVM controller 114 decompresses or compresses that media file. In some embodiments, NVM controller 114 and NVM buffer memory 116 may each be separate integrated circuits (e.g., included within the same NVM package 110) with suitable physical connections coupling the two integrated circuits together. As another embodiment, NVM controller 114 and NVM buffer memory 116 may each be included in the same integrated circuit. In this case, NVM controller 114 and NVM buffer memory 116 can be a highly integrated unit capable of accessing and processing data very rapidly. In some embodiments, however, NVM buffer memory 116 may not be included in NVM package 110. In this scenario, since all controllers can typically include at least a small amount of inherent memory, NVM controller 114 may use its inherent memory as necessary when processing data (e.g., when decompressing media files stored in NVM dies 112).

Application processor 120 can be a separate component from NVM package 110 (e.g., may be located within a separate package or die from NVM package 110) and can control the general operations and functions of media player system 100. For example, application processor 120 can be used to run operating system applications, run firmware applications, run any other suitable applications or software, issue read or write commands to NVM package 110 to obtain data from or store data in NVM dies 112 (e.g., responsive to user inputs and/or the instructions of an application or operating system), or perform any other functions for controlling the general operations of media player system 100. In some embodiments, application processor 120 can share any or all of the processing functions of NVM controller 114. Application processor 120 can include any suitable combination of hardware, software, and firmware for performing these functions.

Application processor 120 can execute NVM driver 122, which may provide vendor-specific and/or technology-specific instructions that enable application processor 120 to interface with NVM package 110. For example, NVM driver 122 can allow application processor 120 to perform various memory management and access functions for NVM package 110.

Memory 130 of media player system 100 can include any suitable type of volatile or non-volatile memory, such as random access memory (“RAM”) (e.g., static RAM (“SRAM”), dynamic random access memory (“DRAM”), synchronous dynamic random access memory (“SDRAM”), double-data-rate (“DDR”) RAM), cache memory, read-only memory (“ROM”), or any combination thereof. Memory 130 can include a data source that can temporarily store user data for programming into or reading from NVM dies 112. In some embodiments, memory 130 may act as the main volatile memory for application processor 120.

Digital-to-analog converter (“DAC”) 140 can convert (and encode/decode, if necessary) analog signals and other signals into digital data, and vice-versa. For example, DAC 140 can convert signals received via input/output (“I/O”) circuitry 150 from any suitable input device (e.g., a microphone, video camera, digital camera, or the like) into digital data. As another example, DAC 140 can convert digital signals (e.g., such as a digital media file stored in NVM dies 112) into an analog signal. I/O circuitry 150 can pass these converted analog signals (e.g., a media file converted into analog format by DAC 140) to any suitable output devices (e.g., speakers, a monitor, and the like) for playback.

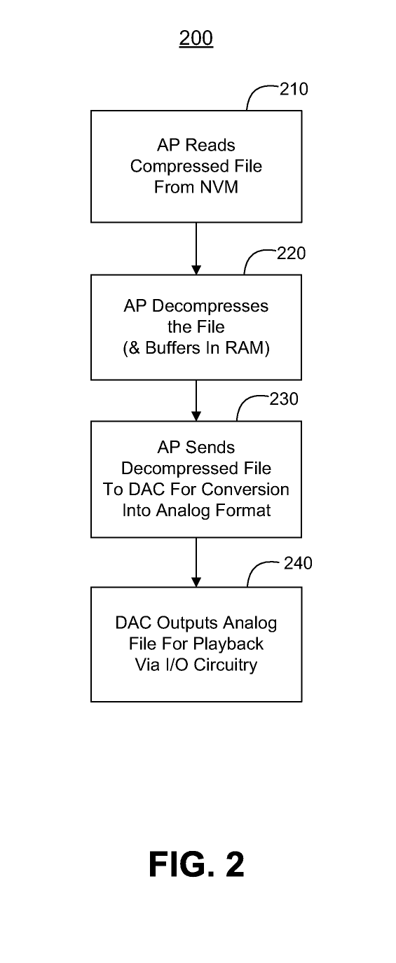

Generally, when playback of a compressed media file is desired, application processor 120 can read the desired compressed media file from NVM dies 112. Application processor 120 may then decompress the media file, and transmit the decompressed media file towards any suitable system components to further prepare the file for playback (e.g., towards DAC 140, I/O circuitry 150, and the like). For example, FIG. 2 shows process 200 that may illustrate such a process.

At step 200 the application processor can read the compressed media file desired for playback from the NVM (e.g., from NVM dies 112 of FIG. 1). The application processor may then decompress the media file using, for example, any suitable CODEC corresponding to the media file (step 220). In some embodiments, the media file data can be buffered in RAM or another suitable memory as the media file is decompressed. For example, the media file data can be buffered in memory 120 of FIG. 1.

At step 230, the application processor can send the decompressed file to a digital-to-analog converter (e.g., DAC 140 of FIG. 1) for conversion into analog format. The analog file can then be output for playback using any suitable system components (step 240). For example, the analog file can be output using I/O circuitry 150 and an output device such as speakers, a monitor, and the like.

In contrast to process 200, however, in some embodiments the NVM package can be used to decompress or otherwise process the desired media file in place of the application processor. This may substantially or entirely remove the application processor from the media playback cycle, thus resulting in power savings and increasing the overall processing speed for the media player system.

For example, as mentioned above, NVM packages can employ a controller chip, such as NVM controller 114 of FIG. 1. Such NVM controllers can include dedicated hardware or otherwise use software implementations to perform a wide range of operations on the data stored in NVM dies 112 (e.g., such as encryption, whitening, decompression, compression, error correction, and the like). Thus, the NVM controller itself can read and decompress media files, and the decompressed media file may then be streamed directly from the NVM package via a dedicated bus line, such as bus line 160 of FIG. 1. Bus line 160 can include, for example, an 12S bus dedicated to NVM package 110, or any other suitable bus line. Thus, by using bus line 160 to output the decompressed media file directly to DAC 140 or other output circuitry, application processor 120 can be substantially removed from the media playback process (e.g., and bus lines 170 and 180 may be unused during the media playback process). In some cases, application processor 120 may only need to give an initial playback request and/or receive a completion confirmation from NVM package 110, and otherwise can remain in an off or low-power state.

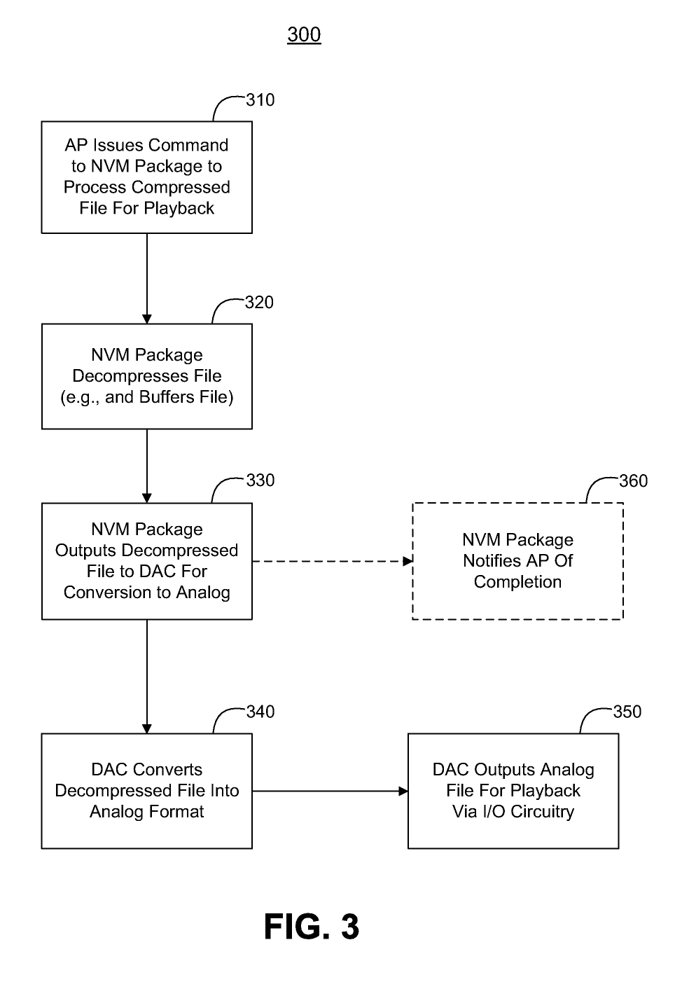

FIG. 3 shows illustrative process 300 for decompressing and streaming a media file with an NVM. At step 310, the application processor can issue an initial command to the NVM package to process a particular media file for playback. For example, application processor 120 can issue such a command to NVM controller 114 of NVM package 110 of FIG. 1. As an illustration, the application processor may have issued this command responsive to user inputs and/or instructions from an application requesting the media file's playback.

At step 320, the NVM package (e.g., NVM controller 114 of FIG. 1) may read the compressed media file from memory and decompress it. For example, NVM controller 114 can read the desired media file from NVM dies 112, and then may decompress the media file using any suitable CODEC. In some embodiments, during the decompression the media file data can be buffered in memory such as NVM buffer memory 116 of FIG. 1 or an inherent memory within NVM controller 114.

At step 330, the NVM package may then output the decompressed file to a digital-to-analog converter for conversion into analog format. For example, the decompressed file can be output via a dedicated bus line that couples the digital-to-analog converter to the NVM package, such as bus line 160 of FIG. 1. In this manner, the decompressed file can be directly output from the NVM package without the application processor ever encountering the media file. In fact, the application processor may never receive the media file in either a decompressed or compressed format and may be substantially removed from process 300.

At step 350, the digital-to-analog converter (e.g., DAC 140 of FIG. 1) can output the analog media file for playback via I/O circuitry. For example, the analog media file can be passed to I/O circuitry 150 of FIG. 1 and then passed to an output device such as speakers, a monitor, or the like.

In some embodiments, a completion confirmation can be alternatively provided to the application processor (optional step 360). For example, NVM package 110 can send a completion confirmation to application processor 120 after the media file has been decompressed, after the media file has been output from NVM package 110, or after any other suitable stage of the media playback process has been completed. While the NVM package is processing the media file (e.g., between steps 310 and 360 of FIG. 3), the application processor could be kept in an off state or in a low-power state. This may provide significant power savings for the media player system and can substantially increase its battery life. Alternatively, the application processor could be used by the media player system to perform other system functions (e.g., running system applications, and the like) while the NVM package is processing the media file. This can allow the media player system to multitask and can increase the overall operating speed and processing power of the media player system.

In some cases, the application processor can store the media file in the NVM package in a form that is more suitable or easier for the NVM controller to decompress. In other words, the application processor can perform any suitable transformations on the media file (e.g., while still leaving the media file in a compressed format) before storing that media file in the NVM controller. This transformation can be done in anticipation of NVM controller subsequently decompressing the media file, such that when the NVM controller does decompress the media file (e.g., step 320 of process 300), the NVM controller instead processes a transformed version of the media file which easier to decompress.

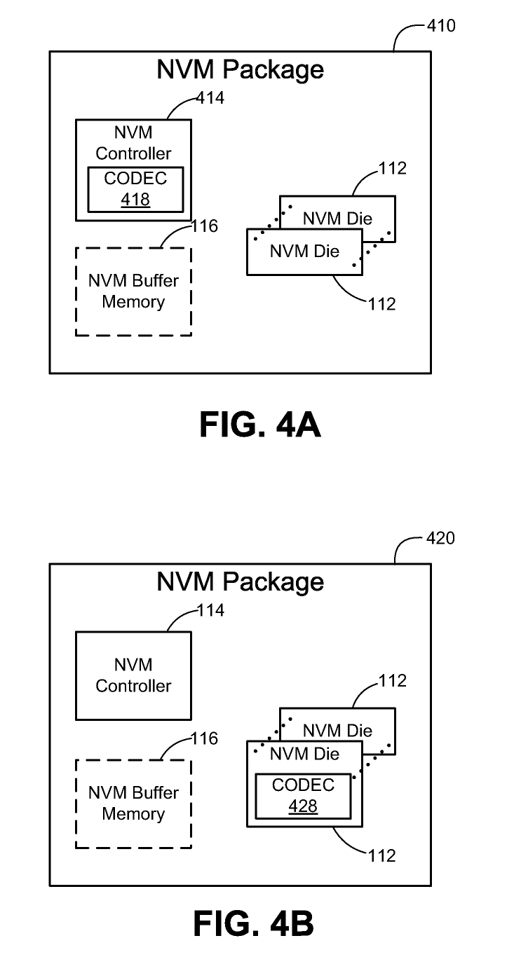

As mentioned in step 320 of process 300, an application processor can use a CODEC corresponding to the desired media file in order to decompress that media file. In some embodiments, the NVM controller can include custom hardware for decoding various types of compressed media files (e.g., hardwired with AAC CODEC, hardwired with mp3 CODEC, hardwired with jpeg CODEC, and the like). As an example, FIG. 4A shows NVM package 410 illustrating hardwired CODEC. In particular, NVM controller 414 of FIG. 4 can include hardwired CODEC 418.

In FIG. 4A, like numbers corresponding to other figures can represent the same system components. For example, NVM dies 112 and NVM buffer memory 116 of FIG. 4A can correspond to NVM dies 112 and NVM buffer memory 116 of FIG. 1, respectively. In general, in the figures disclosed herein, like numbers shared between the figures can represent the same or similar system components.

In some embodiments, the necessary CODEC could alternatively be stored as software. For example, FIG. 4B illustrates NVM package 420. In NVM package 420, CODEC 428 can be store as various data portions in NVM dies 112. CODEC 428 may then be recalled from storage as needed for decompression. In some embodiments, a hybrid version of FIGS. 4A and 4B could be used with CODEC both hardwired into the NVM controller and stored as software in the NVM dies. For example, the NVM package could originally be hardwired with relevant CODEC. Software updates could then be provided by storing CODEC into the NVM dies as new decompression/compression schemes and types of compressed files become available.

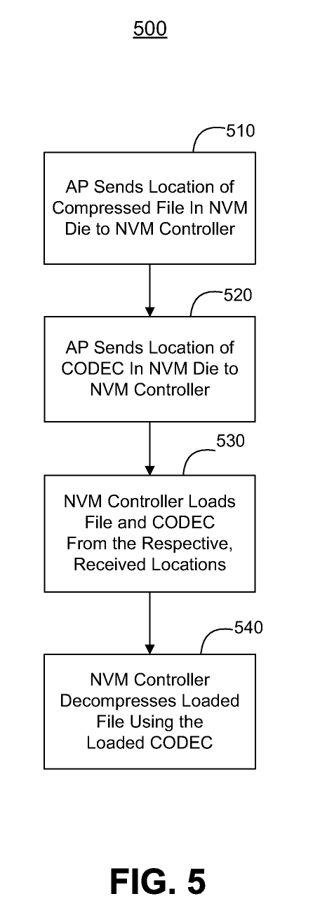

When the CODEC is stored in the NVM dies, in some embodiments the application processor can instruct the NVM controller on which CODEC should be used to decompress a particular media file. For example, the application processor can provide the NVM controller with both instructions to decompress a particular media file and the location of the CODEC (e.g., the location in NVM dies 112 of FIG. 1) which should be used in the decompression process. FIG. 5 shows process 500 which can illustrate such a technique. For example, processor 500 may illustrate steps 310 and 320 of FIG. 3 in greater depth by detailing how the application processor may issue commands to the NVM package and how the NVM package may respond.

At step 510, the application processor can send the location of the compressed media file to the NVM controller. For example, application processor 120 of FIG. 1 could send the physical page address or physical block address of the compressed media file in NVM die 112 to NVM controller 114. Alternatively, application processor 120 could send a logical page address or a logical block address to NVM controller 114. In this case, NVM controller 114 could perform the logical-to-physical address mapping to determine the physical location of the media file within NVM die 112.

At step 520, the application processor can send the location of a particular CODEC suitable for decompressing the media file of step 510 to the NVM controller. For example, once again the application processor could send either a physical page/block address or a logical page/block address to the NVM controller.

At step 530, the NVM controller can load the compressed media file and the CODEC from their respective locations received at steps 510 and 520. The CODEC and media file could be loaded into a volatile memory, such as NVM buffer memory 116 of FIG. 1 or into an inherent buffer memory within NVM controller 114.

At step 540, the NVM controller can decompress the media file using the CODEC, both of which were loaded at step 530. After step 540, the decompressed media file can be output from the NVM package towards a media playback device and/or any other suitable processing can be performed on the decompressed media file. For example, steps such as step 340, 350, and/or 360 of FIG. 3 could be performed after step 540.

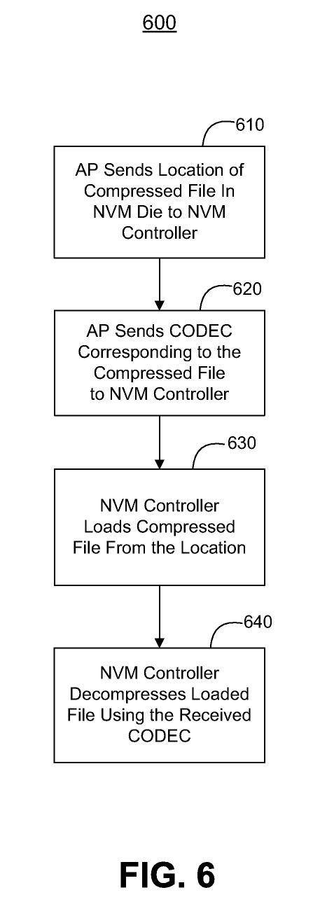

In some embodiments, rather than sending a location of the CODEC to the NVM package, the application processor my send the CODEC itself. For example, such a technique is illustrated by process 600 of FIG. 6. Similar to process 500, process 600 may also illustrate steps 310 and 320 of FIG. 3 in greater detail. However, process 600 may correspond to an embodiment in which the NVM package does not have suitable CODEC either hardwired into the NVM controller or stored in the NVM dies, and thus the CODEC is sent to the NVM package from the application processor.

At step 610, the application processor can send the location of the compressed media file to the NVM controller. Similar to step 510 of FIG. 5, the application processor could send either a physical page/block address or a logical page/block address to the NVM controller. The application processor may then also send suitable CODEC for decompressing the media file to the NVM package (step 620). The received CODEC may be stored in any suitable memory of the NVM package such as, for example, NVM buffer memory 116 of FIG. 1 or an inherent memory with NVM controller 114.

At step 630, the NVM controller can load the compressed media file from the location received at step 610. The NVM controller may then decompress the loaded media file using the CODEC which was received at step 620 (step 640). Similar to process 500 of FIG. 5, after steps 640 the decompressed media file can be output from the NVM package towards a media playback device and/or any other suitable processing can be performed on the decompressed media file. For example, steps such as step 340, 350, and/or 360 of FIG. 3 could be performed after step 640.

As described above, in some embodiments the NVM package can output the media file via a dedicated bus line after decompressing the media file. For example, NVM package 110 of FIG. 1 could output the decompressed media file via dedicated bus line 160 to DAC 140. Alternatively, in some cases the NVM package could output the decompressed media file to the application processor. In this case, the application processor could then forward the decompressed media file to the digital-to-analog converter or towards any other suitable media player system components. For example, application processor 120 of FIG. 1 could receive the decompressed media file and forward it to DAC 140 via bus line 180. An advantage of this embodiment is that the NVM package may still be used to decompress the media file without requiring an additional, dedicated bus line coupled to the NVM package (e.g., such as bus line 160).

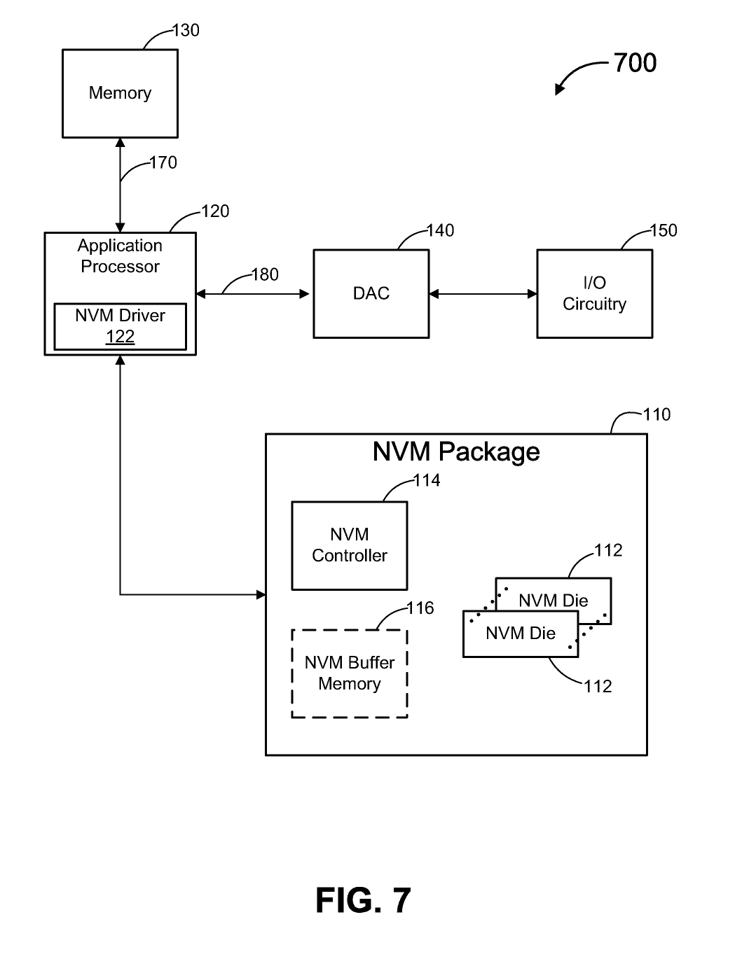

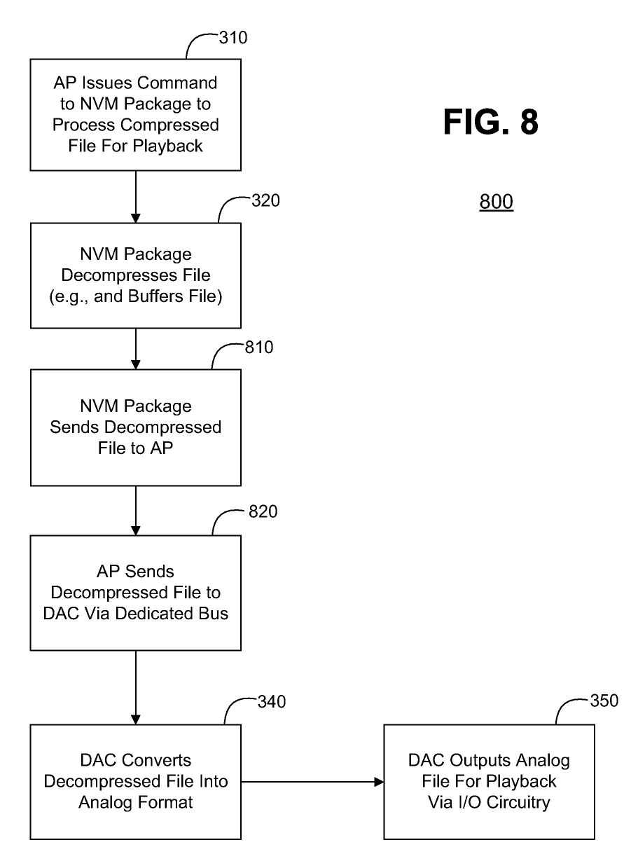

For example, FIG. 7 shows media player system 700 that does not include bus line 160. Rather, media player system 700 can forward a media file decompressed by NVM package 110 towards output circuitry via application processor 120 and bus line 180. FIG. 8 shows process 800 for streaming a media file via the media player system 700 of FIG. 7.

In process 800, steps 310 and 320 can correspond to steps 310 and 320 of FIG. 3, respectively. For example, in steps 310 and 320, the application processor can issue a command to process a compressed media file and the NVM package can decompress this media file. Dissimilar to FIG. 3, however, process 800 may then proceed to step 810 in which the NVM package sends the decompressed file to the application processor. For example, NVM package 110 of FIG. 7 can send the decompressed media file to application processor 120.

At step 820, the application processor may then forward the decompressed media file to a digital-to-analog converter via the application processor's own bus line. For example, the application processor can forward the decompressed media file to DAC 140 of FIG. 7 via bus line 170 and/or bus line 180.

After step 820, process 800 may then proceed to steps 340 and 350, which may correspond to steps 340 and 350 of FIG. 3. For example, at steps 340 and 350, the digital-to-analog converter can convert the decompressed media file into an analog format and then output the analog file for playback via input/output circuitry (e.g., via I/O circuitry 150 of FIG. 7).

In some cases, the application processor may forward the decompressed media file to other channels than the digital-to-analog converter (e.g., step 820 of process 800 and its following steps can be modified). For example, the decompressed media file could alternatively or additionally be forwarded via a communication link such as a universal serial bus (“USB”), an Ethernet connection, a WiFi connection, a Bluetooth™ connection, or via any other suitable communication link. In this case, the decompressed media file can be output via the communication link to external devices (e.g., a personal computer, another media playback device, a cellular phone) for media playback and/or storage.

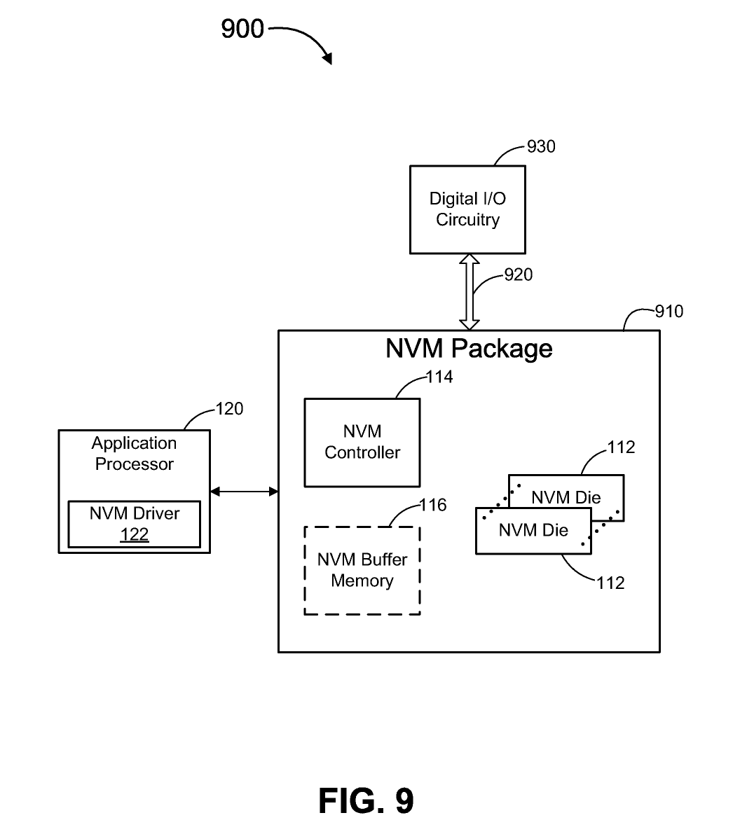

In some embodiments, the NVM package could additionally include a digital output interface. For example, FIG. 9 shows media player system 900 including NVM package 910, where NVM package 910 can have digital output interface 920. For example, digital output interface 920 could include a Sony/Philips Digital Interconnect Format (“S/PDIF”) or other suitable digital output interface. Digital output interface 920 can allow NVM package 910 to send digital media files directly for playback without first requiring conversion to analog form. Accordingly, the need for a digital-to-analog converter can be removed from media player system 900. Rather, NVM package 910 can couple directly to digital I/O circuitry 930 which may then transmit the digital media file towards any suitable digital output devices (e.g., digital output speakers, digital output monitor, and the like).

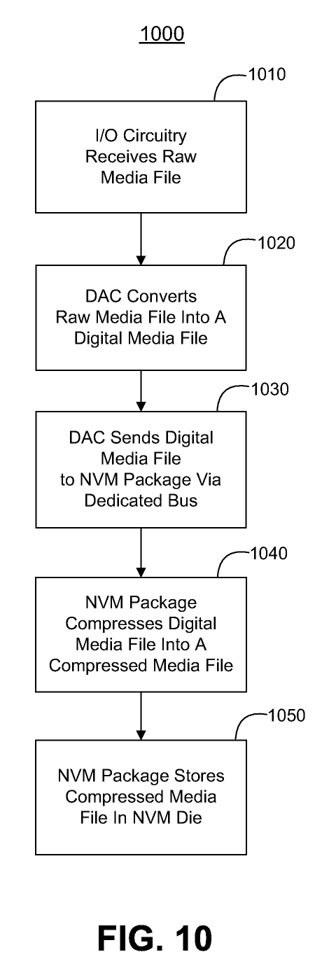

Moreover, although NVM packages have been described herein with the capability to decompress files, one skilled in the art could appreciate that the same techniques and embodiments could be applied to compress files with an NVM package. For example, an NVM controller could apply suitable CODEC for compressing a received file. The CODEC may be hardwired into the NVM controller, stored as software within the NVM dies, received from the application processor or from another component of the media player system, or any combination of the above. This media file may have been received in raw format via any suitable input device, such as a raw media file received via speakers, via a digital camera, via a video camera, or the like. The raw media file may then be forwarded to the NVM package (e.g., after any suitable analog-to-digital conversion, or the like) for compression and storage. FIG. 10 shows process 1000 which can illustrate such a compression technique.

At step 1010 of process 1000, input/output circuitry can receive a raw media file. For example, I/O circuitry 150 of FIG. 1 can receive a raw media file from an input device such as speakers, a digital camera, a video camera, or the like. The raw media file can then be forwarded to a digital-to-analog converter, such as DAC 140 of FIG. 1, which can convert the raw media file into a digital format (step 1020).

At step 1030, the digital-to-analog converter can send the digital media file to the NVM package. For example, DAC 140 can send the digital media file to NVM 110 via bus line 160.

The NVM package may then compress the digital media file at step 1040. For example, NVM package 110 can compress the digital media file using CODEC hardwired into NVM controller 114, using CODEC stored in NVM die 112, and/or using CODEC received from application processor 120.

After the media file has been compressed, it may then be stored within the NVM package (step 1050). For example, the compressed media file can be stored within NVM die 112 of FIG. 1. Once again, since the compression and storing of the media file can all take place directly within the NVM package, the application processor may never encounter the media file and can be substantially removed from the process. During this time, the application processor may then be left in an off or low-power state (e.g., thereby conserving power for the media system) or may perform other functions (e.g., thus allowing the media player system to multitask and increasing the overall operating speed of the system).

It should be understood that the processes described above are merely illustrative. Any of the steps may be removed, modified, or combined, and any additional steps may be added or steps may be performed in different orders, without departing from the scope of the invention.

The described embodiments of the invention are presented for the purpose of illustration and not of limitation.

What is claimed is:

1. A system comprising:
an application processor; and
a non-volatile memory (“NVM”) package separate from the application processor, wherein the NVM package is operable to:
store at least one compressed media file;
receive a request from the application processor to process the at least one compressed media file for playback; and
decompress the at least one compressed media file into a decompressed media file in response to receiving the request.

2. The system of claim 1, further comprising:
a digital-to-analog converter (“DAC”) operable to:
receive the decompressed media file from the NVM package; and
convert the decompressed media file into an analog media file.

3. The system of claim 2, wherein the DAC receives the decompressed media file from the NVM package via a dedicated 12S bus line.

4. The system of claim 2, further comprising:
input/output (“I/O”) circuitry operable to:
receive the analog media file from the DAC; and
playback the analog media file via a media output device.

5. The system of claim 1, wherein the NVM package is further operable to:
send a completion confirmation to the application processor in response to decompressing the at least one compressed media file.

6. The system of claim 5, wherein the application processor remains in at least one of an off state and a low-power state until the completion confirmation is received from the NVM package.

7. The system of claim 1, wherein:
the NVM package is further operable to send the decompressed media file to the application processor; and
the application processor is further operable to:
receive the decompressed media file from the NVM package; and
send the decompressed media file to a digital-to-analog converter for conversion into an analog format.

8. The system of claim 1, wherein:
the application processor is operable to send a particular CODEC to the NVM package; and
the NVM package is further operable to decompress the at least one compressed media file using the particular CODEC.

9. The system of claim 1, wherein:
the application processor is operable to send to the NVM package a location of a particular CODEC stored in the NVM package; and
the NVM package is further operable to:
access the particular CODEC from the location; and
decompress the at least one compressed media file using the particular CODEC.

10. A non-volatile memory (“NVM”) package of an electronic device, the NVM package comprising:
at least one NVM die operable to store at least one compressed media file; and
an NVM controller operable to:
access the at least one compressed media file from the at least one NVM die;
decompress the at least one compressed media file into a decompressed media file; and
output the decompressed media file from the NVM package.

11. The system of claim 1, wherein the at least one NVM die comprises at least one NAND flash memory.

12. The NVM package of claim 10, further comprising:
a buffer memory operable to buffer the at least one compressed media file while the NVM package is decompressing the at least one compressed media file.

13. The NVM package of claim 12, wherein the buffer memory and the NVM controller are comprised on a single integrated circuit.

14. The NVM package of claim 12, wherein the buffer memory and the NVM controller are each comprised on a different integrated circuit.

15. The NVM package of claim 12, wherein the buffer memory is comprised from an inherent buffer memory within the NVM controller.

16. The NVM package of claim 10, further comprising:
a digital output line, and wherein the NVM controller is operable to output the decompressed media file from the NVM package via the digital output line to a digital media playback device.

17. The NVM package of claim 10, wherein:
the at least one NVM die is operable to store a particular CODEC program; and
the NVM controller is further operable to:
access the particular CODEC program; and
decompress the at least one compressed media file using the particular CODEC program.

18. The NVM package of claim 10, wherein a particular CODEC is hardwired into the NVM controller, and wherein the NVM controller is further operable to decompress the at least one compressed media file using the particular CODEC.

19. A method for processing a compressed media file for playback via a non-volatile memory (“NVM”) package of a media player system, the method comprising:
receiving a request to process a compressed media file with the NVM package, wherein the compressed media file is in storage within the NVM package;
in response to the receiving, accessing the compressed media file from storage within the NVM package;
decompressing the accessed compressed media file with the NVM package to generate a decompressed media file; and
outputting the decompressed media file from the NVM package.

20. The method of claim 19, wherein the request to process the compressed media file is received from an application processor of the media player system, wherein the application processor is separate from the NVM package.

21. The method of claim 19, further comprising:
in response to the outputting, sending a completion confirmation to an application processor of the media player system, wherein the application processor is separate from the NVM package.

22. The method of claim 19, wherein the decompressing comprises:
decompressing the accessed compressed media file with an NVM controller of the NVM package.

23. The method of claim 19, further comprising:
receiving a raw media file with the NVM package; and
compressing, with the NVM package, the raw media file into a compressed media format.

24. The method of claim 19, wherein the raw media file is received by the NVM package from at least one of an audio input device and a video input device.
